(19) United States
(12) Patent Application Publication
(10) Pub. No.: US 2015/0265489 A1
(43) Pub. Date: Sep. 24, 2015

(54) STABILITY RING

(71) Applicant: Department of Veterans Affairs, Washington, DC (US)

(72) Inventors: Rosalind Mandelbaum, Providence, RI (US); Albert Lo, Hamden, CT (US)

(21) Appl. No.: 14/662,043

(22) Filed: Mar. 18, 2015

Related U.S. Application Data
(60) Provisional application No. 61/954,680, filed on Mar. 18, 2014.

(51) Int. Cl. A61H 3/00

(52) U.S. Cl. CPC A61H 3/008; A61H 2003/007

(57) ABSTRACT

An apparatus for ambulatory support comprising a stability ring, one or more stability cables, a swivel joint, and a connector. The stability cables are attached on a first end to the stability ring, and attached on a second end to the swivel joint. The connector is attached to the swivel joint. The connector is configured to attach to an overhead structure.

### RELATED APPLICATION

The present application claims priority to U.S. provisional patent application No. 61/954,680 filed 18 Mar. 2014, which is incorporated herein by reference in its entirety.

### BACKGROUND

1. Field of the Invention

The present invention relates, in general, to rehabilitation support, and more particularly to an apparatus for ambulatory rehabilitation. The present invention relates to a stability ring that provides for upper body and lower body support for ambulatory related rehabilitation.

2. Related Art

Rehabilitation is a process of enhancing and restoring functional ability and quality of life to those with physical impairments or disabilities. Various methods of ambulatory rehabilitation, such as dancing, provide a fun and useful way to encourage those with physical disabilities to progress through rehabilitation or other forms of physiotherapy. Such ambulatory rehabilitation methods may involve rigorous activity that may be too challenging for some people.

The present disclosure is directed toward overcoming one or more of the problems discovered by the inventors.

### SUMMARY

An apparatus to support and aid the user's stability while dancing or performing other methods of ambulatory rehabilitation is described herein. The apparatus for ambulatory support comprises a stability ring, one or more stability cables, a swivel joint, and a connector. The stability cables are attached on a first end to the stability ring, and attached on a second end to the swivel joint. The connector is attached to the swivel joint. The connector is configured to attach to an overhead structure.

### BRIEF DESCRIPTION OF THE DRAWINGS

The structure and operation of the present invention will be understood from a review of the following detailed description and the accompanying drawings in which like reference numerals refer to like parts and in which:

FIG. 1 is a front view of a stability ring in accordance with an embodiment of the invention;

FIG. 2 is a front view of the stability ring depicted in FIG. 1, further including a frame structure, in accordance with an embodiment of the invention;

FIG. 3 is front view of the stability ring depicted in FIG. 1, further including a harness, in accordance with an embodiment of the invention.

FIG. 4 is a front view of a user and the stability ring depicted in FIG. 3.

### DETAILED DESCRIPTION

Apparatus and methods for ambulatory rehabilitation which provide the user with stability support are described herein. After reading this description, it will be apparent to one skilled in the art how to implement the invention in various alternative embodiments and alternative applications. However, although various embodiments are described herein, it is understood that these embodiments are presented by way of example only, and not as limitations. As such, the detailed description of various alternative embodiments should not be construed to limit the scope or breadth of the present invention as set forth below.

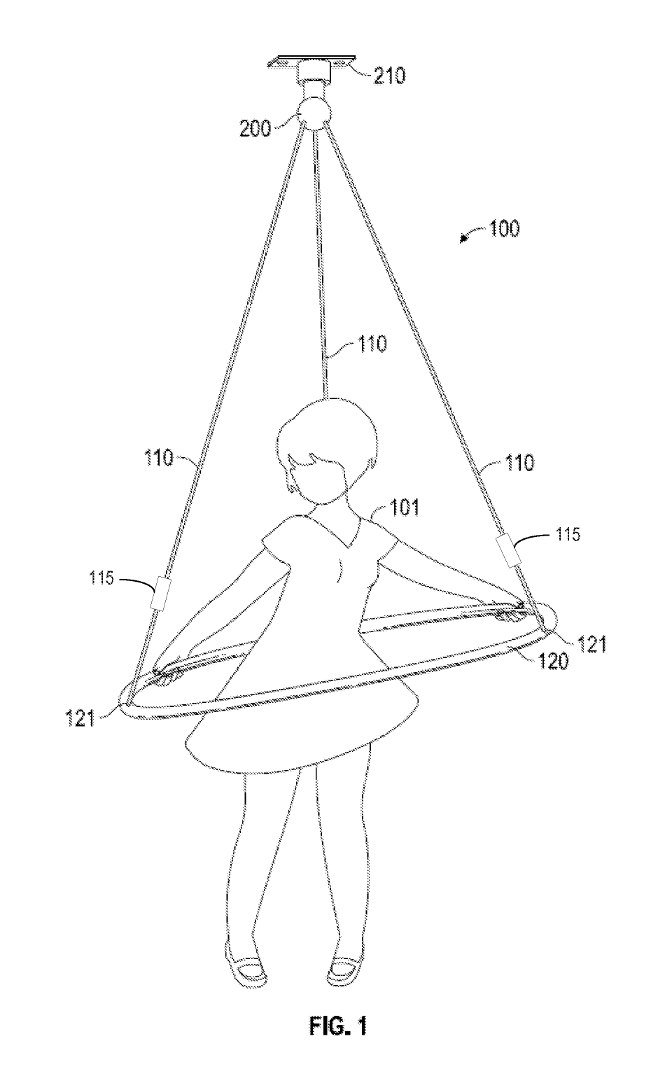

FIG. 1 depicts an embodiment of a user 101 operating the stability ring apparatus 100. As shown in the figure, the stability ring apparatus 100 comprises a stability ring 120, a plurality of stability cables 110, a swivel joint 200, and a connector 210. In one embodiment, the stability ring apparatus 100 includes three stability cables 110. In other embodiments, the stability ring apparatus 100 may include one or more stability cables 110. Each stability cable may include two opposite proximal and distal ends. One distal end of the stability cables 110 may be releasably or fixedly attached to the stability ring 120 at one of the stability ring holes 121. The opposite proximal end may be releasably or fixedly attached to the swivel joint 200. In the figures, some of the lines and surfaces depicted may have been left out or exaggerated for clarity and easy of explanation.

In certain embodiments, the stability ring holes 121 may be positioned equidistantly from one another around the circumference of the stability ring 120. This may provide for even balance of the stability cables 110 when connected to the stability ring 120 at the stability ring holes 121. In other embodiments, the stability ring holes 121 may be positioned non-equidistantly wherein the stability ring holes 121 are positioned towards the back of the stability ring to allow for more room for the user 101. The stability cables 110 may be attached to the stability ring holes by methods including, but not limited to: tying, gluing, taping, or clamping. The swivel joint 200 may also include holes spaced equidistantly from one another around the circumference of the swivel joint 200. This may also provide even balance of the stability cables 110 while hanging from the swivel joint 200. The swivel joint 200 may swivel or spin as the user 101 operates the stability ring apparatus 100.

In certain embodiments, a proximal end of each stability cable 110 may be looped through two holes of the swivel joint 200. The proximal end may first be routed into one hole of the swivel joint 200, and then routed out another hole of the swivel joint 200. In certain instances, the proximal end is routed out through a center hole of the swivel joint 200. After routing through the holes of the swivel joint, the proximal end of the stability cable 110 may be inserted and fastened into a releasable buckle or clamp (not shown). This may be done for each stability cable 110. The releasable buckle may provide for adjustable height of the stability ring 120. In other embodiments, the stability cables 110 may be fastened to the swivel joint 200 by a camber lock mechanism (not shown). The stability cables 110 may also be fastened to the swivel joint 200 by a releasable metal D-ring. In embodiments where the stability cable 110 is releasably attached to the stability ring 120, a similar attachment as described above may be used to attach the stability cable 110 to the stability ring 120.

The stability cables 110 may be composed of a flexible material such as, but not limited to, cloth, nylon, polyester, or plastic. The stability cables 110 may be constructed to withstand heavy forces and loads from users of varying mass.

In some embodiments, the stability cables 110 may include a piston attachment 115. The piston attachment 115 may further aid in support of the user 100 while operating the stability ring apparatus 100. The piston attachment 115 may be used to adjust the height of the stability ring without manually adjusting the swivel joint. In particular embodiments, the piston attachment 115 may be secured remotely by the user from a standing position. The piston attachment 115 may also be adjusted to increase or decrease tension in the stability cables 110.

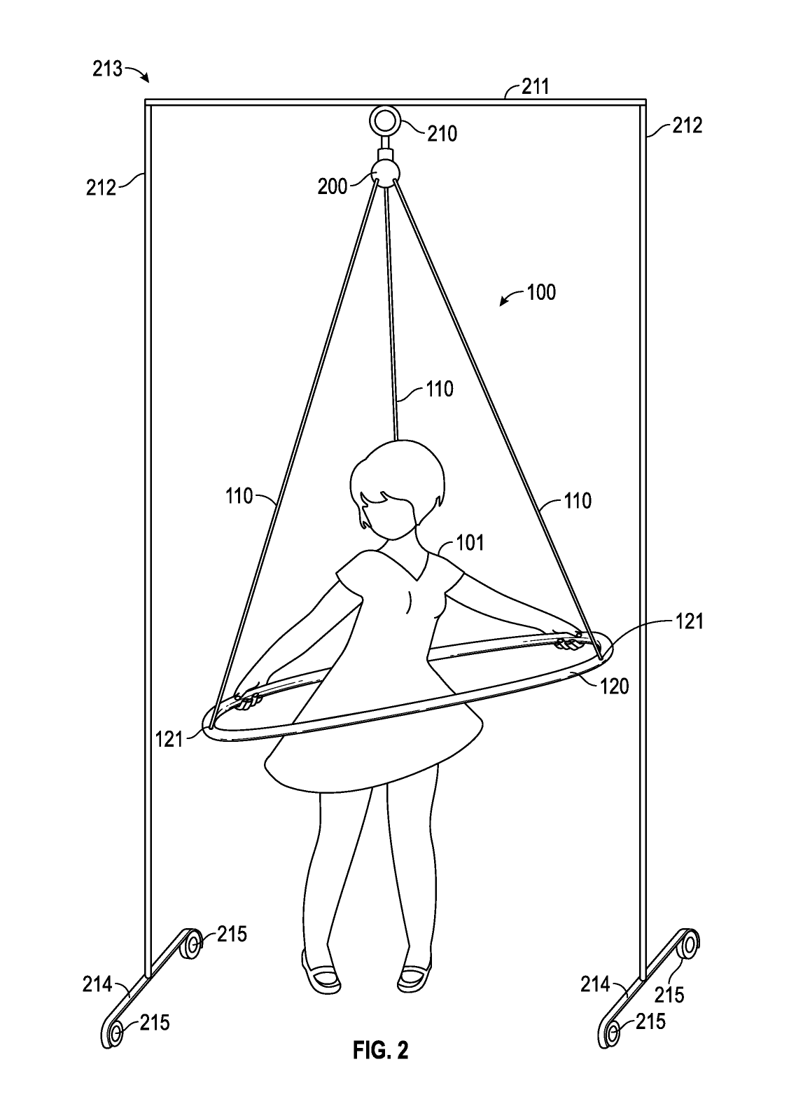

The swivel joint 200 may be fixedly attached to the connector 210. The swivel joint 200 may be attached to the connector 210 by methods including, but not limited to: fusing, welding, bolting, screwing, or snap-fitting. In some embodiments, the swivel joint 200 and connector 210 are manufactured together in one piece. The connector 210 may be of varying structure to accommodate various overhead attachments. As shown in FIG. 1, the connector 210 may be a bracket used to attach to an overhead structure. For example, the connector 210 may be a bracket and screwed into the overhead lintel of a doorway. In other embodiments, such as shown in FIG. 2, the connector 210 may be a ring used to attach to an overhead bar. In such instances, the connector 210 may be easily detached from the overhead structure.

The stability ring 120 may include a circumference between 28 inches to 48 inches. In some embodiments, the circumference of the stability ring 120 may be adjustable. The height of the ring, in a preferred embodiment, is about the waist of the user 101. The height of the ring may be adjustable by adjusting the buckle position of the stability cable 110. In some embodiments, the stability ring 120 may be composed of carbon fiber, aluminum, or plastic, or some other lightweight and rigid material. Additionally, the stability ring 120 may include an exterior surface that provides for secure gripping. A rubber, cloth, or silicon liner may be added or attached to portions or all of the stability ring 120 to provide for such secure gripping.

As shown in FIG. 1, the user 101 may grasp and hold the stability ring 120 using her hands. The user 101 may hold onto the stability ring 120 to support her body weight during operation of the stability ring apparatus 100. By doing so, the user 101 may perform certain exercises or dance techniques with the aid of the support of the stability ring apparatus 100. Dance methods or styles, such as, but not limited to, salsa, tap, waltz, hip hop, and country, may be learned while using the stability ring apparatus 100. Such dance methods may include turns, spins, multi-directional movements, or bilateral or unilateral lower body movements in space that result in dynamic shifts in balance point which may lead to a loss of balance. The support of the stability ring apparatus 100 may prevent the user 101 from falling and injuring herself. This may be important if the user is undergoing rehabilitation due to an injury or some kind of physical disability.

FIG. 2 depicts the stability ring apparatus 100 within a frame structure 213. The frame structure 213, for example, may be composed of a plurality of vertical members 212 and one or more overhead cross members 211. The vertical members 212 may each include casters 215 directly on the bottom ends of the vertical members 212 or indirectly attached via caster legs 214. The casters 215 may provide portability to the frame structure 213 and allow the stability ring apparatus 100 to be easily transported. The casters may be attached to caster legs 214. In addition, caster legs 214 may be foldable or retractable.

In some embodiments, the frame structure 213 may be a doorway. In other embodiments, the frame structure 213 may include only the overhead cross member 211. In such embodiments, the overhead cross member 211 may include the ceiling of a room where multiple stability ring apparatuses 100 may be attached to the overhead cross member 211 at various designated positions. Such embodiments may be used in a classroom type setting. Additionally, the overhead cross member 211 may be a long steel bar where multiple stability ring apparatuses 100 may be attached. In embodiments with a detachable connector 210, the stability ring apparatus 100 may be easily transported amongst different frame structures 213.

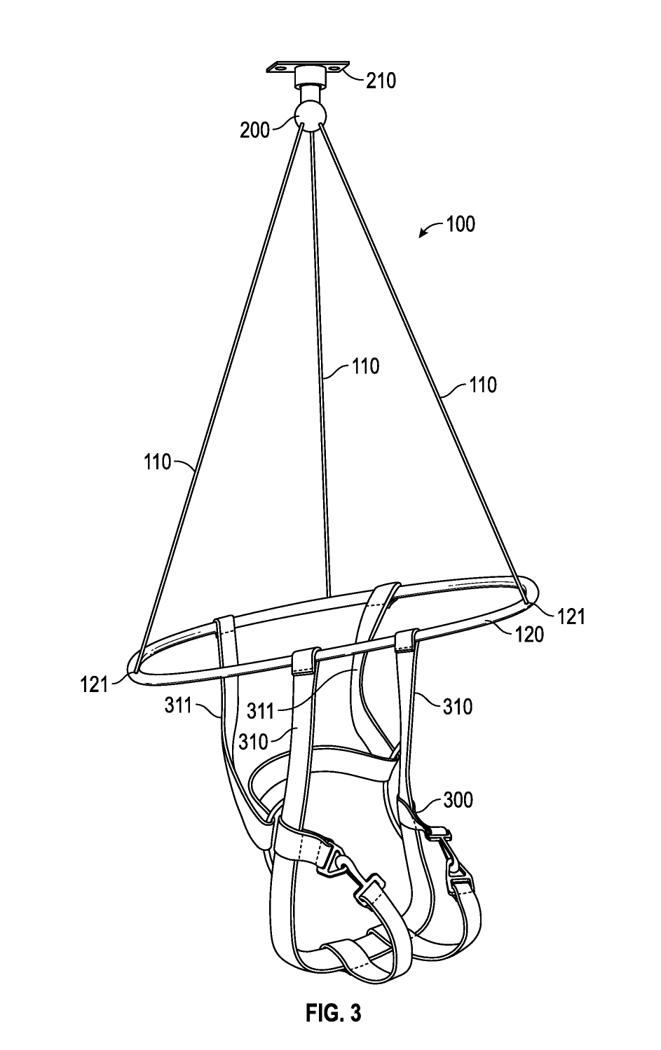

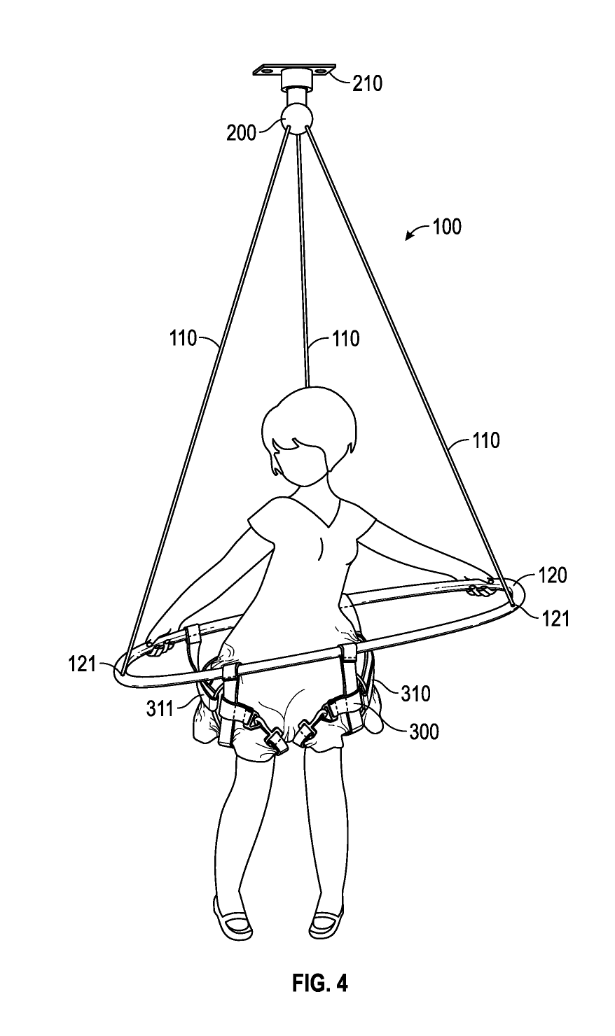

FIG. 3 depicts the embodiment of the stability ring apparatus 100 of FIG. 1 with a harness 300. The harness 300 may provide for additional support for the user's weight. This may be important if the user has weak lower and/or upper body strength. The harness 300, in one embodiment, may include a plurality of front straps 310 and a plurality of back straps 311. In certain embodiments, the harness 300 may include one front strap 310 and/or one back strap 311. The front straps 310 and the back straps 311 may be attached to the stability ring 120 by a variety of means. When attached, the harness 300 may be centered in the middle of the stability ring 120. The harness 300 provides holes to accommodate the legs of a user, such as depicted in FIG. 4. Once the user's legs are through the holes, the harness 300 may wrap around the hips of the user 100. In some embodiments, the front straps and back straps may be adjustable and allow the user to tighten the harness or adjust the height of the harness relative to the stability ring 120.

The preceding detailed description is merely exemplary in nature and is not intended to limit the invention or the application and uses of the invention. The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

What is claimed is:

1. An apparatus comprising:
a stability ring;
a swivel joint;
one or more stability cables, each stability cable having a first end and a second end, wherein the first end is connected to the stability ring and the second end is connected to the swivel joint; and
a connector attached to the swivel joint on a first end and configured to attach to an overhead structure on a second end.

2. The apparatus of claim 1, further including three stability cables.

3. The apparatus of claim 1, wherein the overhead structure is attached to two vertical members.

4. The apparatus of claim 3, wherein the overhead structure and two vertical members comprise a door frame.

5. The apparatus of claim 3, wherein a caster leg and at least one caster are attached to each vertical member.

6. The apparatus of claim 5, wherein each caster leg is retractable.

7. The apparatus of claim 1, wherein the overhead structure includes a plurality of designated locations for attachment to the connector.

8. The apparatus of claim 1, wherein the connector is detachable from the overhead structure.

9. The apparatus of claim 8, wherein the connector is a D-ring connector.

10. The apparatus of claim 1, wherein the stability cables are adjustable to alter the height of the stability ring.

11. The apparatus of claim 1 having at least two stability cables, wherein the at least two stability cables are attached at equidistant locations around the stability ring.

12. The apparatus of claim 1, wherein the stability ring has a circumference between 28 inches and 48 inches.

13. The apparatus of claim 1, further including a harness.

14. The apparatus of claim 1, wherein stability cables further include a piston attachment.

15. The apparatus of claim 1, wherein the stability ring comprises a material selected from the group consisting of: carbon fiber, aluminum, and plastic.

16. A method comprising:
holding a stability ring while performing ambulatory movements;
wherein the stability ring includes
a swivel joint;
one or more stability cables, each stability cable having a first end and a second end, wherein the first end is connected to the stability ring and the second end is connected to the swivel joint; and
a connector attached to the swivel joint on a first end and configured to attach to an overhead structure on a second end.

17. The method of claim 15, wherein the ambulatory movements are part of a dance method.

18. The method of claim 16, wherein the height of the stability ring is adjusted for different dance methods.

19. The method of claim 15, wherein the ambulatory movements are part of a physiotherapy method.

20. The method of claim 15, wherein the stability ring further includes a harness.
